(19) United States
(12) Patent Application Publication
(10) Pub. No.: US 2023/0057947 A1
(43) Pub. Date: Feb. 23, 2023

(54) METHOD AND SYSTEM FOR RECYCLING PAPER

(71) Applicant: ND Paper, Oakbrook Terrace, IL (US)

(72) Inventor: Liu Ming Chung, Dongguan City (CN)

(21) Appl. No.: 17/521,811

(22) Filed: Nov. 8, 2021

Related U.S. Application Data
(60) Provisional application No. 63/110,891, filed on Nov. 6, 2020.
(60) Provisional application No. 63/211,350, filed on Jun. 16, 2021.

(51) Int. Cl. D21B 1/10

(52) U.S. Cl. CPC D21B 1/10

(57) ABSTRACT

Disclosed is a method and system for recycling waste paper that employs mechanical force to reduce the waste paper to its constituent fibers. The disclosed method does not require the addition of chemicals or heat to the pulping process, but instead uses impact and frictional forces to break the waste paper down into fiber. The disclosed method also requires very little water, thus reducing the need for complicated water purification systems.

### TECHNICAL FIELD

The invention relates to a method of recycling waste paper. More specifically, the claimed method relates to a method for extracting fiber from waste paper and even more specifically, extracting the fiber from Old Corrugated Container (OCC) using mechanical operations.

### BACKGROUND

Existing processes of waste paper recycling most often involve mixing waste paper with water and chemicals to break the waste paper down. The waste paper is then chopped up and heated, which breaks it down further into strands of cellulose, a type of organic plant material. This resulting mixture is called pulp, or slurry. The pulp is strained through screens, which remove plastic and other materials that may still be in the mixture. The pulp is then cleaned, de-inked, bleached, and mixed with water. This process is very water and energy intensive.

What is needed is a more efficient process for recycling paper to pulp. It would be further beneficial to develop a process which does not require the addition of chemicals to the waste paper. Additionally, it would be beneficial to provide a recycling process that uses very little water. It would be further beneficial to create a process for recycling paper that reduces the waste involved in conventional waste paper recycling operations.

The foregoing background discussion is intended solely to aid the reader. It is not intended to limit the innovations described herein, nor to limit or expand the prior art discussed. Thus, the foregoing discussion should not be taken to indicate that any particular element of a prior system is unsuitable for use with the innovations described herein, nor is it intended to indicate that any element is essential in implementing the innovations described herein. The implementations and application of the innovations described herein are defined by the appended claims.

### SUMMARY

In accordance with one aspect of the disclosure, disclosed is a method for recycling waste paper that employs mechanical force to reduce the waste paper to its constituent fibers. The disclosed method does not require the addition of chemicals or heat to the pulping process, but instead uses impact and frictional forces to break the waste paper down into fiber. The disclosed method also requires very little water, thus reducing the need for complicated water purification systems. Moreover, the disclosed method is very energy and space efficient in comparison to existing technologies.

### BRIEF DESCRIPTION OF THE DRAWINGS

FIG. 1 shows waste paper at each step of the process of the claimed invention from waste paper in the upper left, to shredded waste paper in the upper right to dry pulp in the lower right which is then formed into bales as shown in the lower left.

FIG. 2 shows a waste paper scrapping machine as may be used in the first step of processing waste paper in the claimed invention

FIG. 3 shows a secondary paper scrapping machine as may be used to further reduce the size of the waste paper.

FIG. 4 shows a side view of hammermill operation in accordance with the claimed invention.

FIG. 5 shows a pulp fiber packaging machine in accordance with the claimed invention.

FIG. 6 shows a schematic overview of the waste paper processing machine constructed in accordance with the claimed invention.

### DETAILED DESCRIPTION

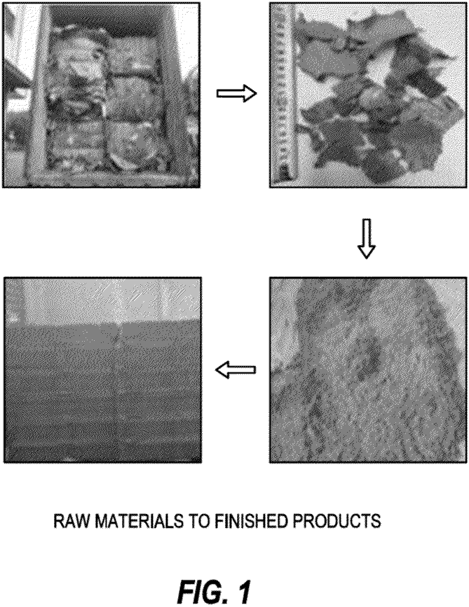

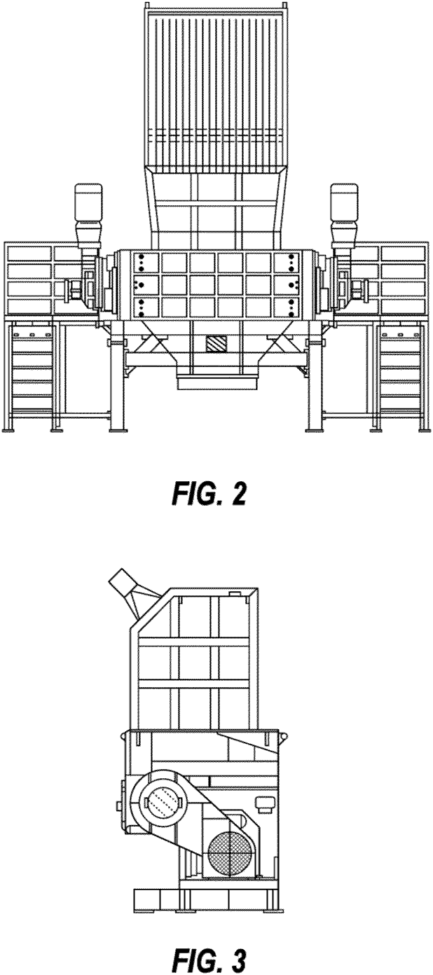

Now referring to the drawings in detail, wherein like reference numerals refer to like elements throughout, FIG. 2 shows a first waste paper shredding operation 21. First waste paper shredding machine 21 is used to reduce the waste paper raw material, typically in large bundles, to smaller pieces of shredded waste paper, typically between 10 cm and 20 cm in any one direction. The shredded waste paper is then conveyed to a secondary shredding operation 31 as shown in FIG. 3. Secondary shredding operation 31 is typically designed to reduce the waste paper size to between 4 cm and 6 cm in any one direction such as might be shown in the upper right of FIG. 1.

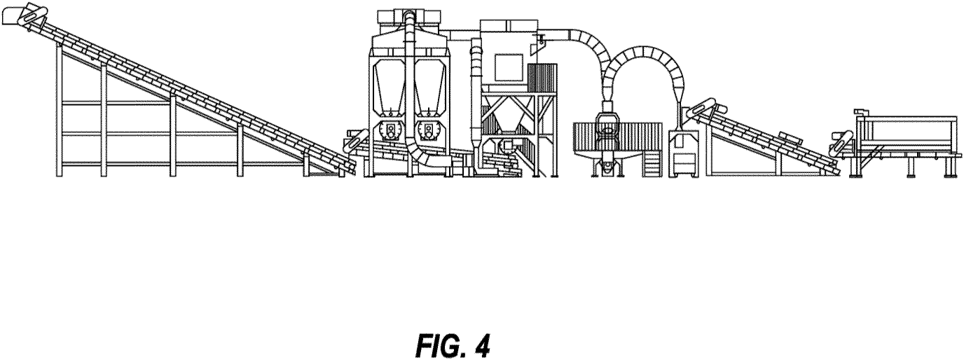

FIG. 4 shows a side overall schematic view of the hammer mill operation 19. Referring now to the individual components of the hammer mill operation 19, a belt conveyor 1 is used to convey bulk waste paper into the hammermill operation 19 from the primary shredding operation 21 or the secondary shredding operation 31. Belt conveyor 1 may include a height barrier 2 to control the flow of waste paper on belt conveyor 1. Belt conveyor 1 directs waste paper (not shown on conveyor) to magnet belt conveyor 4. Magnetic belt conveyor 4 is designed to separate ferrous objects such as staples, clips and the like from the waste paper. Removing such ferrous objects protects downstream machines from damage and provides for purer end product. Magnetic belt conveyor 4 also comprises a height control barrier 3 to control and even the flow of waste paper on the magnetic belt conveyor 4.

Magnetic belt conveyor 4 moves material to pneumatic conveyor 5. Pneumatic conveyor 5 also serves to filter out heavy objects from the flow of waste paper. Pneumatic conveyor 5 is used to transfer the waste paper to hammermill 7. A sprinkler system (not shown) may be used to add moisture to the waste paper to keep down dust and reduce the risk of fire. The waste paper material is fed into the grinding chamber of the hammermill 7, where it is reduced in size by a combination of the repeated impacts of the ganged hammers in the milling chamber, collisions with the walls of the grinding chamber and the impact of waste paper repeatedly impacting other pieces of waste paper. One section of the grinding chamber of the hammermill comprises a screen of uniformly sized apertures. When the particles of waste paper have been reduced in size such that they are able to fit through the screen, the particles may drop through the screen by gravity feed or be evacuated by negative pressure or both. The apertures in the screen of the hammermill may be modified to control the size of the output waste paper fiber.

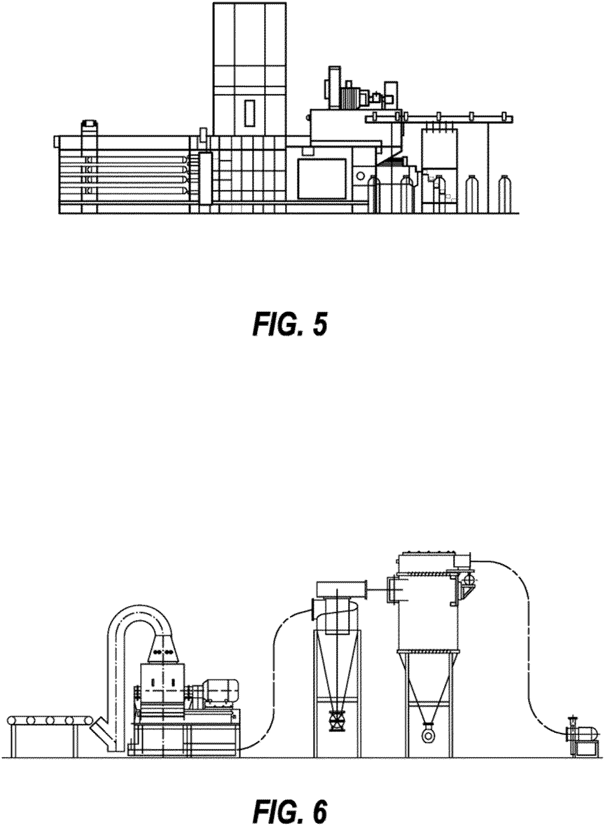

In the embodiment shown in FIG. 6, the now finely particle size waste paper fiber such as that shown in the bottom right of FIG. 1 is collected in the pneumatic collection bin 8 and then conveyed to a separator 13. Prior to entering the separator, sprinkler system may be used to add moisture to the particle size waste paper. The separator 13 is then used to separate the particle sized waste paper fiber from the air. The particle sized waste paper fiber is then deposited on conveyor 16. A sprinkler system may be used on the exit from the separator 13 or on the conveyor 16 to add moisture to the particle size waste paper. Conveyor 16 transfers the particle sized waste paper to a baling or other packaging operation such as that shown in FIG. 5.

### INDUSTRIAL APPLICABILITY

The teachings of the present disclosure can find applicability in many waste paper recycling settings, but may be most useful in recycling OCC. In summary, bales of waste paper, preferably bales of OCC, are fed into first shredding operation to be reduced in size and then to a secondary shredding operation to be further reduced in size. Once reduced in size, the shredded waste paper is conveyed through a magnetic separator designed to separate metal from the shredded waste paper. A pneumatic separator may also be used to eliminate heavier materials from the shredded waste paper. The shredded waste paper is then conveyed to the hammermill where it is broken down to its constituent fibers.

Beneficially, the claimed method uses no chemicals to break down the waste paper Additionally, the claimed process does not use any significant amount of water, nor does it create any potentially polluting exhaust gases. Additionally, power consumption of the claimed method on a per ton basis is substantially lower than that of existing methods for pulping waste paper. Additionally, the claimed method results in a high yield of recycled pulp fiber.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof.

What is claimed is:

1. A method for extracting the fiber from waste paper material comprising the steps of:
providing a shredding operation capable of reducing the waste paper material to smaller pieces;
providing a hammermill operation operable via shearing, frictional and crushing force to reduce the shredded waste paper material to its constituent fibers;
providing a conveying operation operable to convey the shredded waste paper material from the shredding operation to the hammermill operation;
providing a packaging operation to package the waste paper fibers; and
providing a conveyor operable to convey the waste paper fibers to the packaging operation.

2. The method for extracting the fiber from waste paper material of claim 1 wherein the shredding operation is comprised of a first waste paper shredder and a second waste paper shredder.

3. The method for extracting the fiber from waste paper material of claim 1 wherein the shredding operation is comprised of a first waste paper shredder operable to reduce waste paper material to pieces that are no more than about 20 cm in any one direction and a second waste paper shredder operable to reduce waste paper material to pieces that are no more than about 6 cm in any one direction.

4. The method for extracting the fiber from waste paper material of claim 1 wherein the conveyor operable to convey the shredded waste paper material from the shredding operation to the hammermill operation further comprises a magnetized section operable to remove ferrous metals from the shredded waste paper material.

5. The method for extracting the fiber from waste paper material of claim 1 wherein the conveying operation between the shredding operation and the hammermill operation is a pneumatic conveyor.

6. The method for extracting the fiber from waste paper material of claim 5 wherein the pneumatic conveyor is further operable to separate heavier material from the shredded waste paper material.

7. The method for extracting the fiber from waste paper material of claim 1 further comprising a separator operable to separate the fiber created from the waste paper from the air.

8. The method for extracting the fiber from waste paper material of claim 1 wherein the hammermill operation further comprises a screen comprising a plurality of apertures and the apertures may be selectively varied in size.

9. The method for extracting fiber from waste paper material of claim 1 wherein the hammermill operation further comprises a screen comprising a plurality of and wherein negative pressure is used to assist the waste paper fiber in passing through the screen.

10. A method for extracting the fiber from waste paper material comprising the steps of:
providing a shredding operation capable of reducing the waste paper material to smaller pieces, the shredding operation comprised of a first waste paper shredder operable to reduce waste paper material to pieces that are no more than about 20 cm in any one direction and a second waste paper shredder operable to reduce waste paper material to pieces that are no more than about 6 cm in any one direction;
providing a hammermill operation operable via shearing, frictional and crushing force to reduce the shredded waste paper material to its constituent fibers;
providing a conveying operation operable to convey the shredded waste paper material from the shredding operation to the hammermill operation, the conveying operation further comprising a magnetized section operable to remove ferrous metals from the shredded waste paper material; and
providing a packaging operation to package the waste paper fibers; and
providing a conveyor operable to convey the waste paper fibers to the packaging operation.

11. The method for extracting the fiber from waste paper material of claim 10 wherein the conveying operation between the shredding operation and the hammermill operation is a pneumatic conveyor.

12. The method for extracting the fiber from waste paper material of claim 11 wherein the pneumatic conveyor is further operable to separate heavier material from the shredded waste paper material.

13. The method for extracting the fiber from waste paper material of claim 10 further comprising a separator operable to separate the fiber created from the waste paper from the air.

14. The method for extracting the fiber from waste paper material of claim 10 wherein the hammermill operation further comprises a screen comprising a plurality of apertures and the apertures may be selectively varied in size.

15. The method for extracting fiber from waste paper material of claim 10 wherein the hammermill operation further comprises a screen comprising a plurality of and wherein negative pressure is used to assist the waste paper fiber in passing through the screen.
